(19) United States
(12) Patent Application Publication
(10) Pub. No.: US 2011/0034223 A1
(43) Pub. Date: Feb. 10, 2011

(54) System and method for providing and administering a golf contest

(76) Inventors: John O'Leary, North Bergen, NJ (US); Michael O'Leary, North Bergen, NJ (US); Charles Wortmann, Tenafly, NJ (US); Chris Rogovich, Wyckoff, NJ (US)

Correspondence Address: WARD & OLIVO, SUITE 300, 382 SPRINGFIELD AVENUE, SUMMIT, NJ, 07901, US

(21) Appl. No.: 12/462,617

(22) Filed: Aug. 6, 2009

(51) Int. Cl. A63F 9/24; A63F 13/00

(52) U.S. Cl. 463/2; 463/30; 463/42

(57) ABSTRACT

The present invention comprises a novel golf ball tracking system and method. The present invention allows a user participating in a golf competition to track the golf ball with convenience and ease, without purchasing any additional equipment. The device of the present invention comprises a kiosk operably connected to a video camera, wherein the video camera records at least part of a golf competition, and allows a user to purchase the recording, and/or receive a reward for achieving the desired result of a golf competition.

### FIELD OF THE INVENTION

The present invention generally relates to the game of golf and more specifically, the present invention relates to a system and method for providing and administering a golf related contest on a golf course for which prize money may be awarded.

### BACKGROUND OF THE INVENTION

Golf has become one of America's favorite pastime and recreational activity. Currently, there are more than nineteen thousand golf courses within the United States. Additionally, according to the National Golf Foundation more than fifteen million people played at least eight rounds of golf in the United States in 2006.

While playing golf, a participant or golfer uses golf clubs to drive golf balls great distances ultimately to putt the golf ball into a small hole or cup. Generally, a golf course is comprised of eighteen or nine holes, whereby the participant for each hole repeats each of the above-mentioned actions. Challenges in the game of golf arise from the terrain that tends to work against the golfer from delivering the ball to the cup. Such obstacles include doglegs, rough grass, trees, sand traps, water hazards, difficult inclines and slopes, the weather, and the like.

Generally, most holes on a golf course are parthrees, par-fours, or par-fives. In other words, if a particular hole is labeled a par-three, the developer intended for the golfer to complete the hole (have the golf ball land in the cup) by the third shot or stroke. The same logic follows for a hole labeled as a par-four or a par-five. Good or great golfers often shoot below par by sinking the golf ball into the cup with fewer shots than the intended par number of strokes for a particular hole. A score that is one below par for a particular hole is known as a birdie, two below par is an eagle, three below par is an albatross, and four below par is a condor. While birdies may be common for strong golfers, eagles are less so, albatrosses even less so, and condors are the least common.

However, one of the rarest occurrences in the game of golf is a “hole-in-one.” A “hole-in-one” is achieved by landing the golf ball into the hole on a direct shot from the tee box of a particular hole. The resulting number of strokes for the hole is one, hence the term “hole-in-one.” Holes-in-one occur so infrequently that they are often subject to television rebroadcast when captured on video. One could even compare the hole-in-one in golf to the triple play in baseball in that it occurs rarely and is an example of exceptional play.

Since few golfers experience the occurrence of a hole-in-one, when this event does transpire, the golfer who completed the feat often would desire a record of it to convince skeptical friends and to assist in collecting any outstanding wagers, debts, etc.

While most golfers will certainly agree with the premise that golf can be quite challenging, and can certainly be frustrating at times, it is felt that an additional “challenge” or added enjoyment for the golfers is needed, particularly if such is considered from the viewpoint of a combination of skill, amusement, and the potential for remuneration. In particular, in order to impart additional interest or additional competition to a round of golf, not only for an individual golfer who may be a sole participant, but also for a group of golfers playing together, the present invention contemplates and implements a mini-tournament or contest integrally incorporated within the overall round of golf so as not to interfere at all with the overall round of golf, or upset the continuity of the round of golf for the tournament or contest participants or for the non-participating members of the golfing group, or hinder other groups of golfers who may subsequently follow the tournament or contest participants. In particular, the present invention contemplates the implementation and monitoring of a hole-in-one golf competition for either a sole participating golfer or a plurality of golfers playing within a group of golfers. Concomitant to the hole-in-one competition, the present invention likewise contemplates the implementation and monitoring of a golf competition comprising golf tee shots upon a par-three golf hole wherein golfers can effectively be winners of the competition by placing their tee shots either closest to the hole or cup or within specified distances from the hole, such as, for example, within one, two, or three feet of the hole.

The prior art that currently exists in the field disclose systems that monitor and record golf contests via a video camera and VCR or various other types of storage mediums in order to accurately and efficiently conduct the contest. However, the prior art disclose interconnecting each device through power and control lines. Additionally, the prior art disclose coin-operated controls to activate the camera and recording system. The prior art does not disclose a new camera and recording system that is completely solar powered, whereby each device is interconnected completely through a wireless medium. Furthermore, the prior art does not disclose a novel camera and recording system and method that incorporates a wireless kiosk with its own user interactive software, which comprises a touch screen and accepts credit cards, debit cards, smart cards, dollar bills, coins, and the like. Moreover, the prior art does not disclose a golf contest containing a method for providing an interactive advertisement and coupon generating system.

Accordingly, a need exists for a system and method that automatically records the occurrence of a hole-in-one in order to determine if a specific goal of a golf related contest has been achieved. Additionally, a need exists for implementing the system and method completely through solar power while achieving interconnectivity to each component via a wireless medium. Furthermore, a need exists for implementing interactive software onto the system for ease of providing payment, participating in the contest and receiving payment. Finally, a need exists for providing an interactive advertisement that generates coupons for a third party merchant that has been selected by the participant.

### SUMMARY OF THE INVENTION

The present invention overcomes the various deficiencies associated with the prior art by creating a novel golf ball tracking system and method. The present invention allows a user participating in a golf competition to track the golf ball with convenience and ease, without purchasing any additional equipment or devices.

In one embodiment, the system of the present invention comprises a kiosk, which may be present on a golf course. The kiosk of the present invention may contain a display (e.g. screen) for interacting with a user and keeping track of at least one golf ball for at least one player. Additionally, the kiosk of the present invention may contain a video recording device (e.g. video camera) for tracking at least one golf ball for at least one player. Furthermore, the system of the present invention may comprise at least one additional video recording device (e.g. video camera) for tracking at least one golf ball for at least one player. Preferably, the at least one video recording device of the present invention is powered via at least one solar panel, and is connected to the kiosk of the present invention wirelessly.

In one embodiment, the video recording device of the present invention is embodied as a video camera powered by to at least one solar panel. Importantly, the video recording device of the present invention is in communication with the kiosk, preferably through wireless means. Thus, the video recording device of the present invention includes a wireless transmitter in order to transmit captured images and video to the kiosk, as well as a wireless receiver which enables an individual to control the camera remotely (e.g. from the kiosk), and to receive data from the kiosk of the present invention.

In one embodiment, the kiosk is located by a tee area of a golf hole and the video recording device is located by a green area of the golf hole. In the preferred embodiment, the system contained within the kiosk of the present invention is powered by at least one solar panel. Furthermore, the kiosk of the present invention may have at least one antenna, which acts as a data transmitter and receiver.

Additionally, the present invention may include a payment apparatus for receiving payments from a user for any services provided to the user or for any other need, which may become evident upon the implementation of the present invention. The present invention may further include a receipt dispensing apparatus in order to provide a user with a written record of service provided.

In one embodiment of the present invention, a user participating in a golf tournament who wishes to maintain record of the tournament or to track a ball throughout the golf tournament may purchase a service provided with the use of the system of the present invention. The user may receive access information through the kiosk, which enables the user to access data recorded for a specific game, tournament, or location on the golf course. Thus, the user will have accurate independent tracking of his/her performance through out the golf game.

The purchased service will track the golf ball through the game with the help of wireless cameras. The user may then be charged based on a predetermined flat fee, a daily rate, membership rate, a pro rata pricing method, and or based on how often and how much the system of the present invention has been used.

In another embodiment of the present invention, a user participating in the golf contest of the present invention may interact with the advertisement displayed on the screen of the kiosk so as to select the desired third party merchant and subsequently receive a coupon for that particular third party merchant. The coupon is preferably printed on the reverse side of the receipt received by the user for participating in the golf contest of the present invention.

Accordingly, a non-limiting object of the present invention is to enable a user to keep track of a golf ball during a golf game.

Another non-limiting object of the present invention is to provide a system and method, which enables the tracking of a golf ball through a golf game remotely.

Still another non-limiting object of the present invention is to provide a system and method, which enables the tracking of a golf ball without the participation of the player.

Another non-limiting object of the present invention is to enable a user to have independent verification of game related data in a golf game.

Yet another non-limiting object of the present invention is to provide a golf ball tracking system, which is powered using solar panels.

Still another non-limiting object of the present invention is to provide a system having central monitoring of several remote locations on a golf course.

Yet another non-limiting object of the present invention is to provide an interactive advertisement and coupon generating system and method.

Other objects, features, and characteristics of the present invention, as well as the methods of operation and functions of the related elements of the structure, and the combination of parts and economies of manufacture, will become more apparent upon consideration of the detailed description below, all of which form a part of this specification.

### BRIEF DESCRIPTION OF THE DRAWINGS

A further understanding of the present invention can be obtained by reference to preferred embodiments and corresponding alternate embodiments as set forth in the illustrations of the accompanying drawings. Although the illustrated embodiments are merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the present invention, reference is now made to the following drawings in which:

FIG. 1 illustrates a plan view of an entire golf hole and a golf contest system in accordance with the present invention.

FIG. 2 illustrates a front perspective view of the kiosk shown in FIG. 1 in accordance with the present invention.

FIG. 2A illustrates a screen shot displayed on the kiosk shown in FIGS. 1 and 2 once a user has initiated the golf contest in accordance with the present invention.

FIG. 2B illustrates a subsequent screen shot displayed on the kiosk shown in FIGS. 1 and 2 upon a user making a selection in accordance with the present invention.

FIG. 3 illustrates a perspective view of a remote terminal containing a screen with two views of the golf hole shown in FIG. 1 in accordance with the present invention.

FIG. 4 illustrates a block diagram of the system contained within the kiosk shown in FIG. 2 in accordance with the present invention.

FIGS. 5A and 5B are flow charts illustrating the manner in which the software executes the overall process of the present invention in accordance with an embodiment of the present invention.

FIG. 6 is a flow chart illustrating the manner in which a participant may claim a hole-in-one in accordance with the present invention.

FIG. 7 is a flow chart illustrating the manner in which the software executes the advertisement sequence in accordance with the present invention

### DETAILED DESCRIPTION OF THE PREFERRED EMBODIMENTS

Detailed illustrative embodiments of the present invention are disclosed herein. However, techniques, systems, and operating structures in accordance with the present invention may be embodied in a wide variety of forms and modes, some of which may be quite different from those in the disclosed embodiments. Consequently, the specific structural and functional details disclosed herein are merely representative, yet in that regard, they are deemed to afford the best embodiments for the purposes of disclosure and to provide a basis for the claims herein, which define the scope of the present invention. The following presents a detailed description of preferred embodiments (as well as some alternative embodiments) of the present invention.

A further understanding of the present invention can be obtained by reference to a preferred embodiment. Although the illustrated embodiment is merely exemplary of systems for carrying out the present invention, both the organization and method of operation of the invention, in general, together with further objectives and advantages thereof, may be more easily understood by reference to the following description. The description is not intended to limit the scope of this invention, but merely to clarify and exemplify the invention.

Moreover, well known methods, procedures, and substances for both carrying out the objectives of the present invention and illustrating the preferred embodiment are incorporated herein but have not been described in detail as not to unnecessarily obscure novel aspects of the present invention.

The terms used herein, including “user”, “individual”, “purchaser”, “member”, “client”, “golfer”, “player”, “participant”, and “person” are not meant to limit the scope of the invention to one type of entity, as any entity or individual can also utilize the present invention.

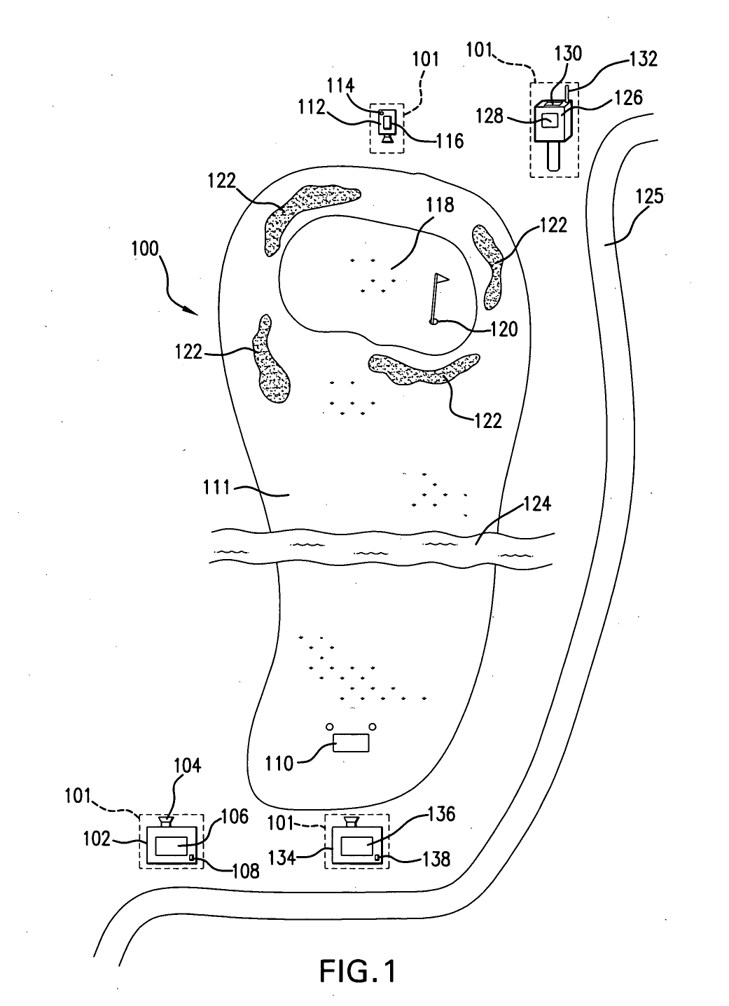

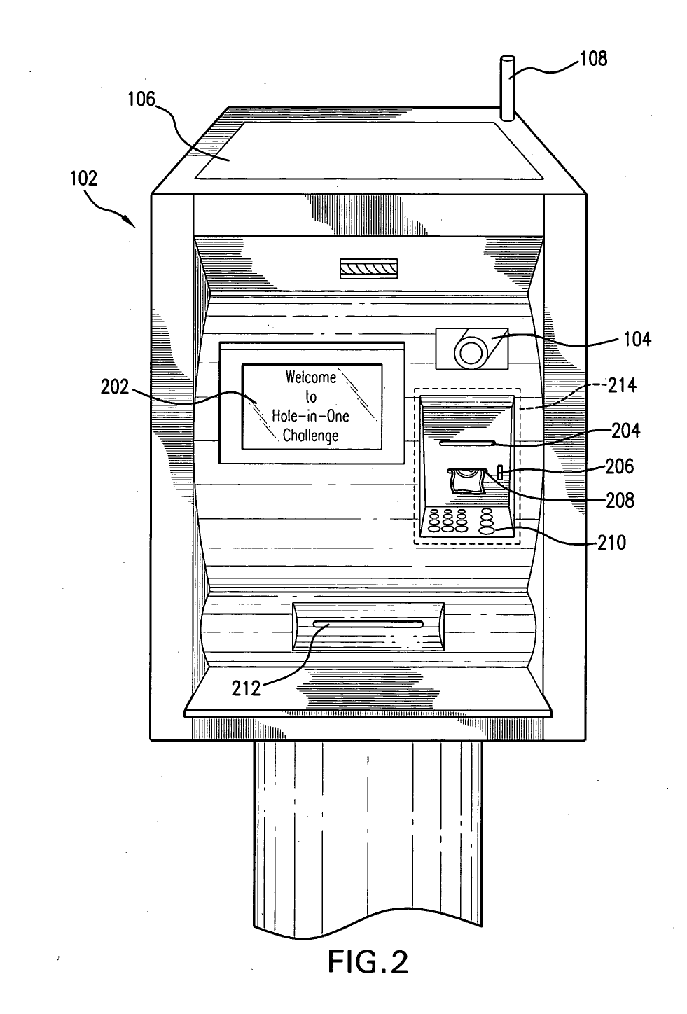

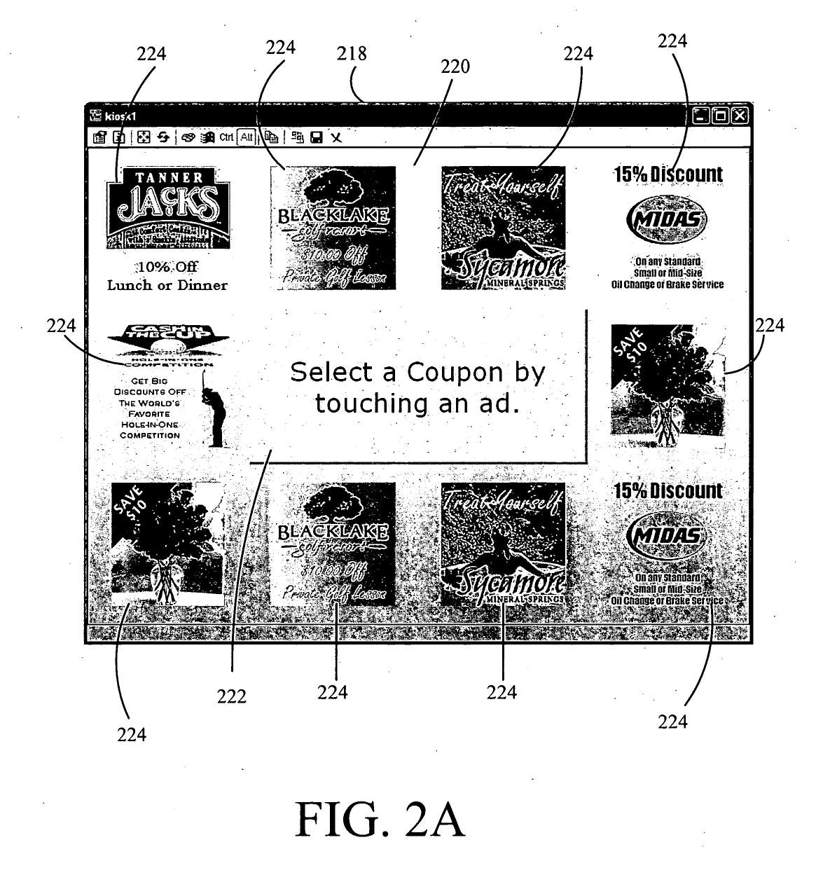

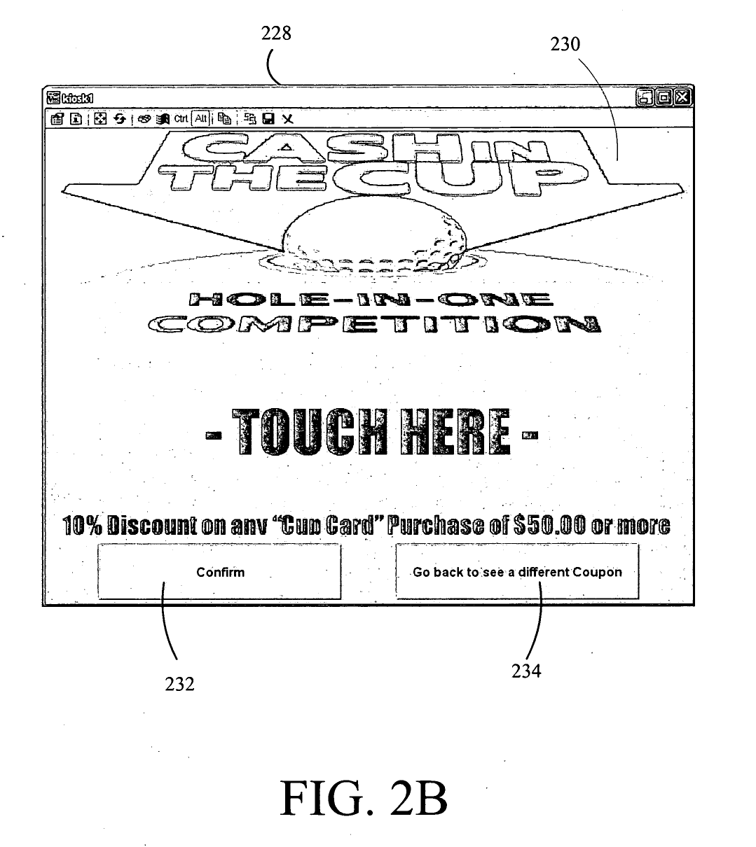

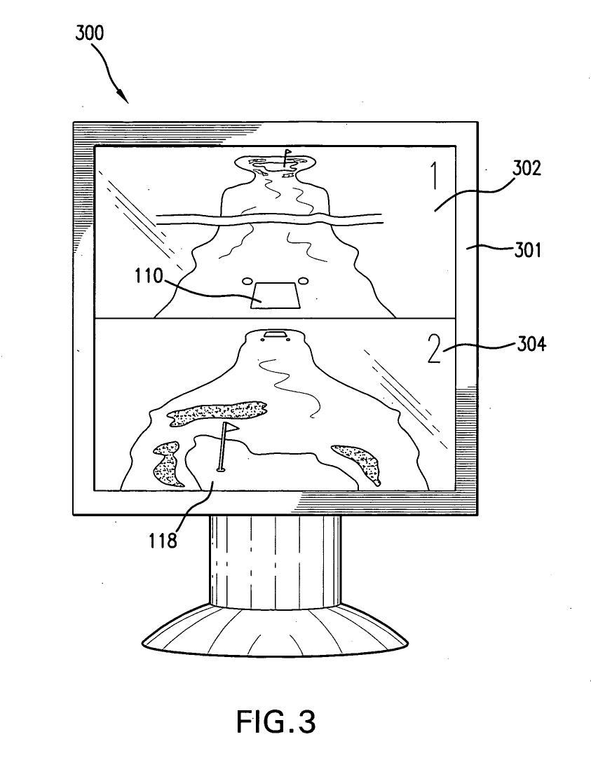

Referring to the drawings, wherein like numerals, indicate like elements throughout, FIG. 1 illustrates a plan view of an entire golf hole 100 of a golf course (not shown) and a golf contest system 101 in accordance with the present invention; FIG. 2 illustrates a front perspective view of a kiosk 102, which is part of golf contest system 101 in accordance with the present invention; FIGS. 2A and 2B illustrate screen shots 218 and 228, respectively, of the interactive advertisement sequence of the present invention; and FIG. 3 illustrates a perspective view of a remote terminal 300 containing a screen 301 with two views 302 and 304 of golf hole 100 of FIG. 1 in accordance with the present invention.

Turning now to FIG. 1, illustrated is an overview of the entire system of the present invention. Generally, golf hole 100 of the present invention is comprised of, but not limited to a tee area or tee-box 110, a fairway 111, at least one sand trap or bunker 122, a water hazard 124, and a putting green 118, which contains a hole or cup 120. More specifically, golf hole 100 of the present invention consists of golf contest system 101, which is preferably comprised of a kiosk 102, a wireless camera 134, a secondary wireless camera 112, a secondary wireless kiosk 126; and a remote terminal 300 (FIG. 3). Furthermore, kiosk 102 is preferably located in close proximity to tee-box 110 of golf hole 100 and is comprised of a camera 104, a solar panel 106, an antenna 108 connected to an internal wireless transmitter and receiver, a display or screen 202 (FIG. 2), a payment apparatus 214 (FIG. 2), and a receipt dispensing member 212 (FIG. 2). Preferably, camera 134 is located in close proximity to tee-box 110 of golf hole 100. Moreover, camera 134 may be located above kiosk 102 via a mounting pole (not shown). Kiosk 102 preferably initiates golf contest system 101 and is preferably in wireless communication with wireless camera 112, camera 134, kiosk 126, and remote terminal (FIG. 3). Any appropriate wireless medium (e.g. cellular, Bluetooth, radio frequency, microwave, infrared, etc.) may be utilized for interconnecting all the above-referenced components of golf contest system 101. It is further contemplated that camera 134 may be wired to kiosk 102 via any appropriate means and thus can receive power from kiosk 102. The functionality of each above-referenced element regarding kiosk 102 will be thoroughly and extensively discussed below.

Wireless camera 134 is preferably located in close proximity to tee box 110 of golf hole 100 and is comprised of an antenna 138 connected to an internal wireless transmitter and receiver, and a solar panel 136. Preferably, solar panel 136 provides power to wireless camera 134 through the photovoltaic effect or any other means commonly known in the art.

Additionally, antenna 138 is used to wirelessly communicate with preferably all the components of golf contest system 101 through any appropriate wireless medium (e.g. cellular, Bluetooth, radio frequency, microwave, infrared, etc.). In operation, wireless camera 134 preferably records a golf ball that is hit by the participant from the prospective of tee-box 110. While wireless camera 134 is capturing video documentation of a golf ball landing on or around putting green 118 or in sight of wireless camera 134, kiosk 102, kiosk 126, remote terminal 300 (FIG. 3), or any other wireless device (not shown) (e.g. cellular telephone, personal digital assistant, etc.) may wirelessly connect to wireless camera 134 for remote viewing (e.g. through streaming).

Wireless camera 112 is preferably located in close proximity to putting green 118 of golf hole 100 and operates in a similar manner as camera 134. Moreover, wireless camera 112 is comprised of an antenna 114 connected to an internal wireless transmitter and receiver, and a solar panel 116. Preferably, solar panel 116 provides power to wireless camera 112 through the photovoltaic effect or any other means commonly known in the art.

Additionally, antenna 114 is used to wirelessly communicate with preferably all the components of golf contest system 101 through any appropriate wireless medium (e.g. cellular, Bluetooth, radio frequency, microwave, infrared, etc.). In operation, wireless camera 112 preferably records golf balls that land on or around putting green 118 or anywhere else in the direct line of sight of wireless camera 112. While wireless camera 112 is capturing video documentation of a golf ball landing on or around putting green 118 or in sight of wireless camera 112, kiosk 102, kiosk 126, remote terminal 300 (FIG. 3), or any other wireless device (not shown) (e.g. cellular telephone, personal digital assistant, etc.) may wirelessly connect to wireless camera 112 for remote viewing (e.g. through streaming).

Additionally, kiosk 102, kiosk 126, remote terminal (FIG. 3), or any other wireless device (not shown) (e.g. cellular telephone, personal digital assistant, etc.) may wirelessly connect to wireless cameras 134 and 112 in order to remotely save a file containing the video captured by wireless cameras 134 and 112 for viewing at a later time. Preferably, the file created during this process may be saved in any file format commonly known in the art (e.g. MPEG, AVI, MP4, MOV, WAV, etc.).

Moreover, kiosk 126 is preferably located in close proximity to putting green 118 of golf hole 100, cart path 124, or the tee-box of the following hole and is comprised of a screen or monitor 128, a solar panel 130, and an antenna 132 connected to an internal wireless transmitter and receiver. If a participant achieves a hole-in-one or believes a hole-in-one has been achieved, the participant may be afforded the opportunity to enter the results at kiosk 126, thus the user does not have to travel back to kiosk 102 to claim the results. Therefore, the existence of kiosk 126 eliminates the time and energy that would otherwise be wasted by traveling back to kiosk 102. Additionally, kiosk 126 assists in integrating golf contest system 101 of the present invention within golf course 100 so as not to interfere with or disturb the continuity of the overall round of golf.

In operation, once a participant takes the tee shot and achieves the hole-in-one, the participant may enter the results into kiosk 126, wherein the participant utilizes screen 128, which is preferably a touch screen, and the user interactive software to enter the results. Upon entering the results, kiosk 126 wirelessly transmits the results to a remote terminal or any other wireless device (e.g. cellular telephone, personal digital assistant, etc.), whereby an employee of the golf course or third party is able to confirm the results and determine if a participant should be awarded a prize. Although, a touch screen has been disclosed, any type of screen as commonly known in the art may be used without limiting the scope of the invention.

A hole-in-one competition will be used to illustrate the present invention; however, any of the below-referenced competitions may be implemented without limiting the scope of the present invention. Therefore, the description below is merely exemplary and should not be considered exhaustive of the types of competition, which may be implemented by golf contest system 101 of the present invention.

Preferably, in operation, a potential participant initiates a golf contest (e.g. a hole-in-one competition, a closest-to-pin competition, a furthest shot competition, or any type of golf related competition) by engaging kiosk 102 of golf contest system 101, whereby camera 104 is preferably activated. Camera 104 is preferably used as a security camera, which captures a frontal image of every participant accessing golf contest system 101. Once the participant enters the required information and pays, preferably camera 134 and camera 112 begin recording. Preferably, the timer within cameras 134 and 112 are set to a one-minute time limit, that is, after the participant successfully pays to participate in the contest, he or she now has one minute to take the tee shot before the cameras deactivate. While the cameras are active, the participant preferably enters tee-box 110 and initiates play on the hole by taking the first shot. Simultaneously, cameras 134 and 112 are preferably active and strategically placed around golf hole 100 so as to obtain a complete and clear view of the entire shot from tee-box 110 to the location where the ball finally comes to rest. It should be appreciated that camera 104 may also be used to capture the golf shot without limiting the scope of the present invention. If a hole-in-one has been achieved, the participant preferably enters the results into kiosk 126, whereby a notification message is wirelessly sent to a remote location (e.g. the ProShop, etc.). Upon receiving the hole-in-one notification, the staff member or organizer of the contest preferably downloads the video file from the camera and determines if the claim is accurate. If the claim is accurate, the participant preferably receives a reward (e.g. prize money, free round of golf, free golf lessons, etc.). However, if the claim is inaccurate or the participant does not claim a hole-in-one, preferably, the golf contest expires for the particular participant. Regardless of the results of the contest, kiosk 102, camera 112, and golf contest system 101 eventually deactivate after a certain period of time, preferably one minute.

In one non-limiting embodiment, the system of the present invention provides a closest-to-the-pin competition among all the players in a golf group. In this embodiment, the system utilizes video analytics technology to automatically detect the location of the hole and to automatically detect the location of each golf ball that lands on the green. Furthermore, the system of the present invention could determine which golf ball has landed closest to the hole and therefore automatically determine which player has won the contest. Additionally, the system could award a prize to a golfer that hits the ball within a certain distance from the hole (e.g., a 1 foot radius). In this case the video analytics could automatically determine if the golf ball hit by the participant has stopped within this predefined range and therefore automatically award the prize to the participant.

It should be appreciated that video analytics technology is commonly used to analyze video for specific data, behavior, objects, or attitude. It has a wide range of applications including safety and security. The software algorithms generally run on processors inside a computer or on an embedded processor in video cameras, recording devices, or specialized video processing units. Additionally, video analytics technology can evaluate the contents of video to determine specified information about the content of the video. More specifically, for the present invention, video analytics would be used to determine the location of golf balls within a predefined range on the green of a golf hole, or to determine which participant's golf ball has landed closest to the hole.

In one non-limiting embodiment, the system of the present invention comprises a central kiosk, which may be present on a golf course at a gathering location (e.g. entrance to the golf course, cafeteria, equipment shop, ProShop, etc.), thus facilitating a convenient means for accessing any video or otherwise game related recorded data stored in the memory of a kiosk or a camera.

In the preferred embodiment, the present invention is embodied as a set of kiosks operably interconnected, and connected to a central kiosk having a database for storing any game related data for at least one user. In this embodiment, the user may approach any of the kiosks and employ predetermined identification data to retrieve any information stored in the kiosk (e.g. video footage of a favorable game outcome). The information may be retrieved on location, uploaded to a wireless device (e.g. cellular telephone, personal digital assistant, portable computer, etc.), or otherwise uploaded to a website for later access by the user.

In another non-limiting embodiment, the present invention may be implemented as a set of independent kiosks having no connection or communication means, wherein each kiosk is associated with a specific predetermined area in the golf course, and provides access to video shot only at those locations. In this embodiment, the user would need to retrieve printed documentation of a claimed event (e.g. hole-in-one) at each kiosk in order to verify a claim pertaining to a specific area-on the golf course. This embodiment of the present invention would allow for a less expensive implementation of the present invention as it requires practically no long-range communicative means.

It will be apparent to those skilled in the art that numerous changes may be made in such details without departing from the spirit and the principles of the invention. It should be appreciated that the present invention is capable of being embodied in various other forms without departing from its essential characteristics.

The kiosk of the present invention may contain a display (e.g. screen) for interaction with a user and visually keeping track of at least one golf ball for at least one player. The display may be implemented as a touch-screen LCD, wherein the user is prompted via recorded audio instructions for interaction with the system of the present invention. Alternatively, the user may be prompted during interaction via text instructions shown on the display. The display of the present invention may be implemented as a CRT, passive LCD, TFT LCD, plasma screen, penetron, or any other display known in the art without departing from the spirit of the present invention.

Furthermore, the system of the present invention may comprise at least one video recording device (e.g. video camera) for tracking at least one golf ball for at least one player. The video recording device may be implemented in a variety of ways.

For example, the cameras may be hidden from the user in order to prevent tampering and ensure an accurate recording of any game play. Alternatively, the cameras used in the present invention may be well marked and appear in a visible area in order to allow the user to choose an angle from which to take their shot which does not block the accurate recording of a particular shot taken.

The video record may then be provided to the users simply as a recording of a video file (e.g. AVI, MPEG, WMV, ASF, etc.) on a compact disc. Alternatively, a user may be able to download the video record through a website to which the video is sent using their home computer; this may be provided at a fee to the user. Any method of providing a user with a visual record may be used without departing from the spirit of the present invention.

Turning now to FIG. 2, illustrated is a front perspective view of kiosk 102 of FIG. 1 in accordance with the present invention. As previously stated, kiosk 102 is comprised of display or screen 202, which is preferably a touch screen. However, any type of screen as commonly known in the art may be used without departing from the spirit of the present invention. Additionally, screen 202 is preferably used to welcome the potential participant, interact with the participant through user-friendly software, initiate the golf contest system 101 (FIG. 1) in order to commence the golf contest, display interactive instructions to the user in order to execute an interactive advertising sequence, and visually keep track of at least one golf ball for at least one player. Furthermore, kiosk 102 is comprised of camera 104, which is activated upon a participant engaging kiosk 102. Camera 104 preferably records an image of every participant that engages kiosk 102. Camera 134 is preferably activated upon receipt of payment and preferably records the tee-box 110 (FIG. 1) and surrounding area in an effort to capture the participant's tee shot. Preferably, camera 134 is used for tracking at least one golf ball for at least one player. Additionally, cameras 104 and 134 may be any type of camera as commonly known in the art. In order to obtain maximum exposure to the sun, solar panel 106 is located preferably on the top portion of kiosk 102. However, solar panel 106 may be placed on any surface deemed appropriate. Preferably, solar panel 106 creates solar power through the photovoltaic effect, yet any method as commonly known in the art may be used without limiting the scope of the invention. As previously stated, kiosk 102 consists of antenna 108, which is connected internally to a transmitter and receiver and is used to transmit and receive communication signals wirelessly to and from various wireless devices within golf contest system (FIG. 1).

Furthermore, kiosk 102 is preferably comprised of a payment apparatus 214, which contains various methods commonly known in the art for making payments so that a golfer may participant in the golf contest of the present invention. Preferably, payment apparatus 214 consists of card accepting device 204, used for accepting a credit card, a debit card, a smart card, a gift card, a “cup card” or any other appropriate card that may be used for providing payments. It should be noted that a “cup card” is a type of gift card designed specifically to be used with the golf contest of the present invention. Preferably, a user can purchase a “cup card” at the ProShop. However, it should be appreciated that a user can purchase a “cup card” at any appropriate venue without limiting the scope of the present invention.

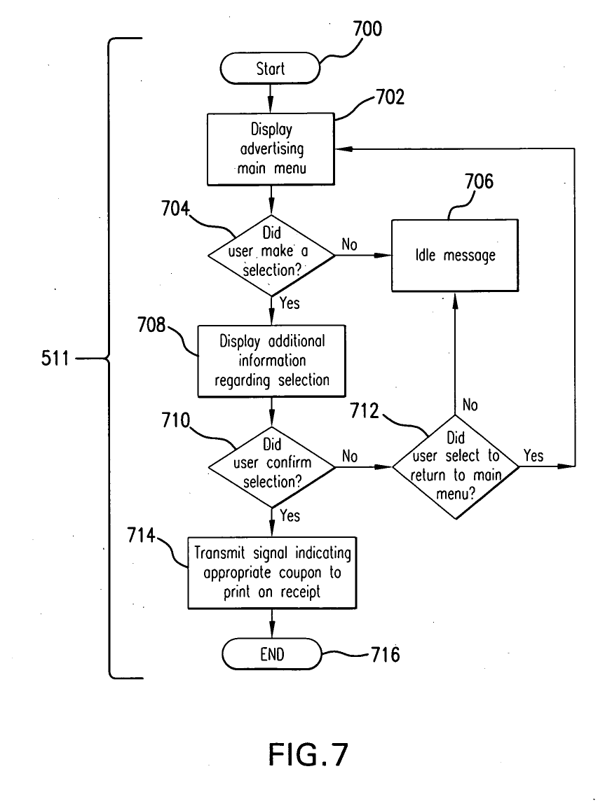

Additionally, payment apparatus 214 consists of a bill accepting device 208 and a coin accepting device 206, which affords the participant the opportunity to pay with dollar bills and coins, respectively. A keypad 210 may also be incorporated within kiosk 102 in an effort to enable additional or supplemental functionality to screen 202. Although paying at kiosk 102 has been disclosed, one could afford participants the opportunity to pay through several other methods without limiting the scope of the invention. For example, one may be able to make a payment via a wireless device (e.g. a cellular telephone, a personal digital assistant, portable computer, etc.) or through a third party that may be running a golf tournament or the like. Additionally, once a participant has made a payment and it has been authorized, a receipt dispensing member 212 preferably presents the participant with a receipt for providing proof of purchase. The receipt also preferably contains a coupon printed on the reverse side to be used at the participating advertiser specifically selected by the user. The method in which the user interacts with the software of kiosk 102 in order to choose the desired coupon will be described in detail below with respect to FIG. 7. Moreover, the receipt provided to the participant may also contain a unique serial number, whereby after participating in the contest, the user may logon to a predetermined website, enter the unique serial number and view the golf shot that he or she hit while participating in the contest.

Furthermore, kiosk 126 is substantially similar to kiosk 102, as described in detail above. Accordingly, any description regarding kiosk 102 may be applied to kiosk 126.

In the preferred embodiment, the video recording device of the present invention is a video camera powered by at least one solar panel. In an alternative embodiment, the present invention is powered through conventional means such as a power line from a central distributing station (e.g. power station). In an alternative, yet non-limiting embodiment, the kiosks of the present invention may be powered by an independent battery contained within each kiosk. Thus, accurate tracking of the golf tournament may take place even in the event of a power outage.

In yet another alternate embodiment, the present invention may have a solar power panel as a primary power supply, as well as a back up electric power storage cell. This allows the kiosks to function properly in the event of a cloudy day or in the event that light is otherwise obscured. In other alternate embodiments, the kiosk of the present invention may be connected to both a solar panel power supply and a central power supply (e.g. electricity delivered from a power station), thus insuring that power is delivered in the instance of a sunless day without relying on portable power source.

Alternatively, the kiosks of the present invention may be operably connected to a solar power source, a backup battery, and a central power delivery source (e.g. local power distribution network). Thus, this non-limiting embodiment ensures the functional operation of the kiosks in the event of both a sunless day and a battery failure. The power source of the present invention may be modified as necessary by environmental, financial, or any other constraints of implementing the present invention in specific circumstances.

It will be apparent to those skilled in the art that numerous changes may be made in such details without departing from the spirit and the principles of the invention:. It should be appreciated that the present invention is capable of being embodied in various other forms without departing from its essential characteristics.

FIG. 2A illustrates screen shot 218, which may appear on screen 202 once a user has engaged kiosk 102 and has chosen to participate in the golf contest of the present invention. Screen shot 218 preferably illustrates an advertisement main menu 220, which comprises on-screen instructions 222 and a plurality of advertising icons 224. Preferably, on-screen instructions 222 serve to interact with and guide the user through an advertising and coupon creating sequence, whereby the user may first view a plurality of icons 224 and subsequently choose to receive a coupon by selecting the desired icon 224.

As shown in FIG. 2A, instructions 222 instruct the user to select a coupon by touching the desired advertisement on touch screen 202. However, it should be appreciated that instructions 222 may instruct a user to press the button of keypad 210 that corresponds to the desired advertisement displayed on screen 202 in order to select the desired coupon. Additionally, it should be appreciated that any method for allowing a user to select the desired coupon may be implemented without limiting the scope of the present invention.

Each icon 224 is preferably a thumbnail image of an advertisement provided by a participating third party merchant. Icons 224 preferably indicate the name of the merchant, the type of business (e.g., golf, eatery, flower vendor, spa, salon, automotive, etc.), and the discount offered with the coupon. Moreover, each icon 224 represents a redeemable coupon. It should be appreciated that icons 224 provided by main menu 220 are merely exemplary and should not limit the scope of the present invention. Additionally, it should be noted that any number of icons may be provided without departing from the spirit of the present invention.

Turning now to FIG. 2B, illustrated is screen shot 228, which depicts additional information 230 regarding the specific icon 224 selected by the user. Preferably, screen shot 228 subsequently appears once a user has touched the desired icon 224 from main menu 220 of screen shot 218. As shown in FIG. 2B, additional information 230 preferably includes the value of the coupon and any limitations a user may have when using the coupon. For example and as shown in FIG. 2B, a user would receive a ten percent discount on the purchase of any “cup card” of $50.00 or more. Additional information 230 may also include the location of the participating businesses, the telephone number, other various options to choose from, terms,and conditions of the coupon, etc. It should be appreciated that additional information 230 may be any appropriate type of information without limiting the scope of the present invention.

Screen shot 228 also includes a plurality of interactive buttons 232 and 234. Interactive buttons 232 and 234 are preferably buttons located on screen 202. However, it should be appreciated that buttons 232 and 234 may be labels for buttons of keypad 210. Preferably, interactive buttons 232 and 234 act as on-screen instructions so as to further interact with the user, whereby the function performed by each respective interactive button 232 and 234 is indicated via text displayed on top of each respective button 232 and 234. Preferably, upon a user touching interactive buttons 232 and 234, the software of the present invention executes the function indicated thereon. Thus, if a user touches interactive button 232, the software will recognize that the user has confirmed his or her selection and subsequently process this decision so that the appropriate coupon is printed on the reverse side of the receipt. Alternatively, the user is also provided with the chance to return to main menu 220 by touching interactive button 234, whereby the software will allow the user to choose another advertisement. It should be appreciated that additional interactive buttons may be included to provide additional functionality to the user without limiting the scope of the present invention.

FIG. 3 illustrates a perspective view of a remote terminal 300 containing a screen or monitor 301 with two views 302 and 304 of golf hole 100 (FIG. 1), in accordance with the present invention. Preferably, monitor 301 is adapted for receiving and displaying two video data streams simultaneously, which are illustrated as view 1 302 and view 2 304 from wireless camera 134 and wireless camera 112 (both of FIG. 1), respectively. Consequently, from view 1 302 a user is afforded the opportunity to view a close-up of tee-box 110. Additionally, from view 2 304 a user is afforded the opportunity to view a close-up of putting green 118. Alternatively, wireless camera 134 and wireless camera 112 (both of FIG. 1) may be situated in any appropriate position in an effort to record various views and angles of a golf hole without limiting the scope of the invention. Furthermore, the two data streams may be wirelessly transmitted through any commonly known wireless medium in the art.

Importantly, the video recording device of the present invention is in communication with the kiosk, preferably through wireless means. Thus, the video recording device of the present invention has a wireless transmitter in order to transmit captured images and video to the kiosk, as well as a wireless receiver which enables an individual to control the camera remotely (e.g. from the kiosk), and to receive data from the kiosk of the present invention.

In some locations, the environmental interference (e.g. naturally occurring magnetic fields and waves) may prevent an effective implementation of the present invention via wireless communication means. Accordingly, in an alternate embodiment, the video recording devices of the present invention may be operably interconnected via a wired network (e.g. CAT5 wiring), without departing from the spirit of the present invention.

Alternatively, the cameras of the present invention may be linked via a wired connection to the nearest kiosk, while the kiosk itself may be operably connected via a wireless network to a central server, where the central server is used for storing data processed by any given kiosk. Additionally, the present invention may be implemented via a local area network thus allowing a user to have access to information stored remotely at a variety of independent kiosks.

The kiosks of the present invention may also be configured to transmit information for storing at a location remote from the golf course, thus ensuring that game related data is not lost in the event that local databases become disabled. This feature of the present invention is especially useful in high stakes official tournaments, and/or whenever access to such data may be crucial in determining the outcome of the tournament.

A variety of different transmission protocols and methods such as cellular, Bluetooth, radio frequency, microwave, infrared, and the like may be used in order to transmit and receive information to and from the cameras respectively, without departing from the spirit of the present invention. It will be apparent to those skilled in the art that numerous changes may be made in such details without departing from the spirit and the principles of the invention. It should be appreciated that the present invention is capable of being embodied in various other forms without departing from its essential characteristics.

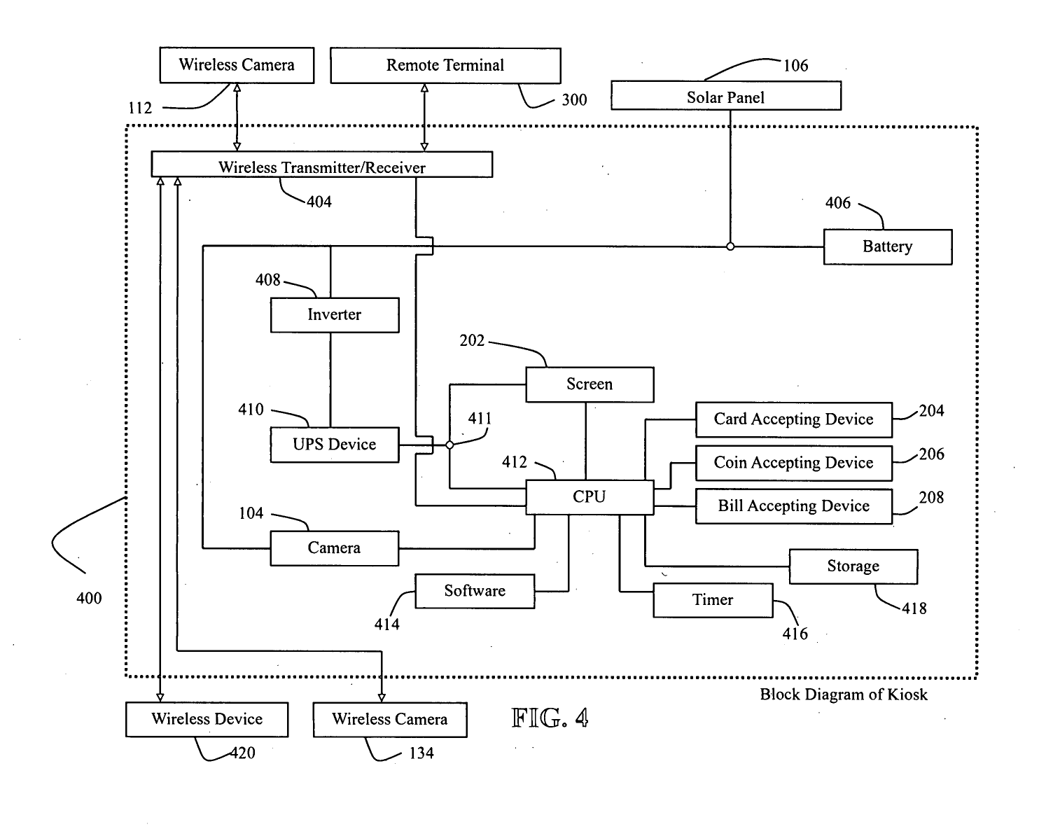

Turning now to FIG. 4, illustrated is a block diagram of a kiosk system 400 contained within kiosk 102 (FIGS. 1 and 2). As previously stated and described above, kiosk 102 (FIGS. 1 and 2) consists of solar panel 106. Preferably, solar panel 106 is enabled for powering a battery 406, an inverter 408 and camera 104. Preferably, inverter 408 converts the direct current from battery 406 into alternating current in order to power central processing unit (“CPU”) 412 and screen 202. Additionally, an uninterruptible power supply (“UPS”) 410 is interconnected within kiosk system 400 between inverter 408 and node 411, which connects to screen 202 and CPU 412 in order to maintain a continuous supply of power when power is not available, in this case, when solar power is unavailable. Any commonly known UPS device may be used without departing from the spirit of the present invention.

Additionally, kiosk system 400 is preferably comprised of a wireless receiver 404, a camera 104, and a screen 202 all interconnected and controlled by CPU 412. Kiosk 102 (FIGS. 1 and 2) wirelessly communicates with wireless cameras 134 and 112, remote terminal 300, and any wireless device 420 (e.g. cellular telephones, personal digital assistants, portable computers, etc.) via its wireless transmitter and receiver 404. It should be appreciated that camera 134 may be in wireless communication with kiosk 102 without limiting the scope of the present invention. Preferably, CPU 412 is comprised of a specific software 414, which is used to control the operation of all the components of kiosk system 400 as well as provide user-friendly access and operability of golf contest system (FIG. 1). Furthermore, CPU 412 is preferably interconnected to and controls a timer 416, a storage device 418 (e.g. ROM, RAM, database, etc.), card accepting device 204, coin accepting device 206, and bill accepting device 208. Timer 416 is used to monitor and control the length of time the kiosk 102 (FIGS. 1 and 2) is in use. Preferably, timer 416 is set to deactivate kiosk 102 (FIGS. 1 and 2) one minute after the payment has been received. Additionally, cameras 134, and 112 contain a similar type of timer. Storage device 418 is preferably used to store files of the videos captured by cameras 104, 134 and 112. Card accepting device 204, coin accepting device 206, and bill accepting device 208 are controlled and operated in a manner that is well known in the art. The method in which software 414 controls the golf contest of the present invention will be thoroughly outlined in the following flow diagram.

In one embodiment, the kiosk is located by a tee area of a golf hole and the video recording device is located by a green area of the golf hole. In another embodiment of the present invention the there are several individual kiosks associated with a given set of cameras, which are independent of other kiosks.

In this embodiment a user seeking to retrieve data (e.g. video, images, etc.) pertaining to a specific area in a golf course, has to retrieve said data from the specific kiosk, which is associated with the relevant cameras. This implementation of the present invention prevents tampering with stored data from a central location.

Alternatively, the user may be provided with a single, central access point that allows access to data recorded at any location on the golf course, this allows for easy access to data in competitions where fear of tampering is not a significant concern (e.g. low stakes competitions, private tournaments, etc.).

In yet another alternative embodiment, several kiosks capable of accessing data-recorded at any other kiosk may be placed at convenient locations throughout the golf course. In this embodiment a user seeking to verify his or her performance in a given golf game may do so conveniently at the location of their choice.

It will be apparent to those skilled in the art that numerous changes may be made in such details without departing from the spirit and the principles of the invention. It should be appreciated that the present invention is capable of being embodied in various other forms without departing from its essential characteristics.

The golf ball tracking service of the present invention may be provided at a cost to the individual user, in this instance the individual seeking to purchase such a service may be required to pay for the service at a central location (e.g. equipment shop at the golf course).

Alternatively, a payment apparatus (i.e. an apparatus that accepts payments via credit card, debit card, smart card, “cup card,” cash, etc.) may be attached to each kiosk, whereby the user is capable of paying for a service upon utilizing the payment apparatus, as such a need arises. The user may then be charged based on a predetermined flat fee, a daily rate, membership rate, a pro rata pricing method, and/or based on how often and how much the system of the present invention has been used.

In yet another embodiment, the user may be required to purchase the service prior to the initiation of a specific tournament. Further, in another alternate embodiment, the service may be paid for by the particular golf establishment holding a tournament, and be provided at no cost to the user.

It will be apparent to those skilled in the art that numerous pricing methods may be used with the system and method disclosed herein, without departing from the spirit and the principles of the invention. It should be appreciated that the present invention is capable of being embodied in various other forms without departing from its essential characteristics.

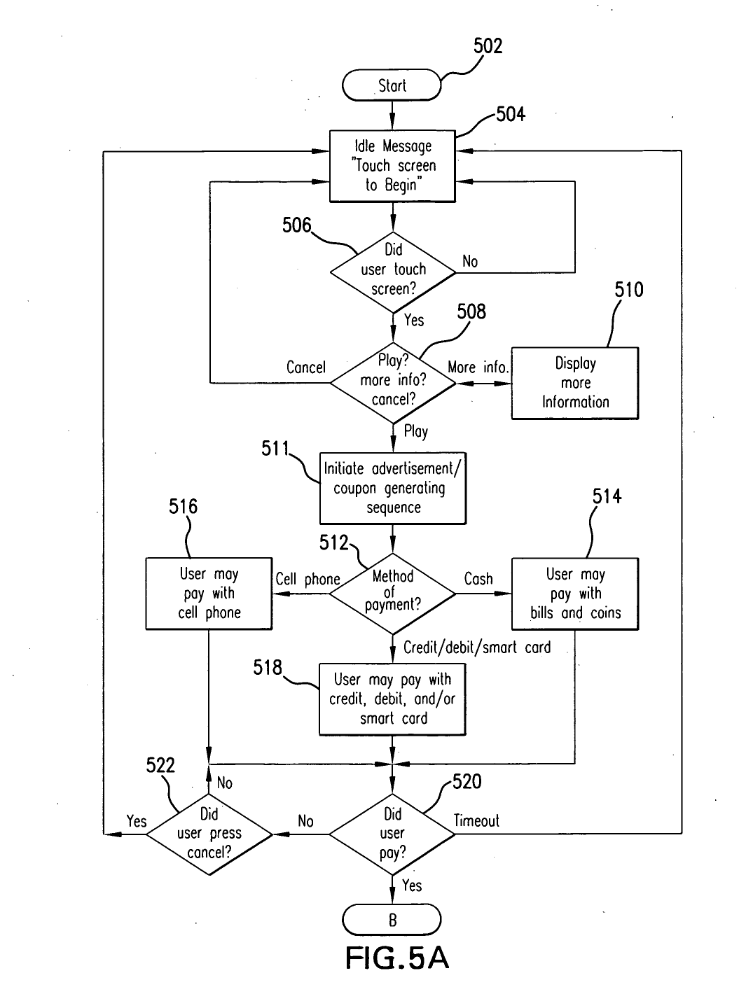

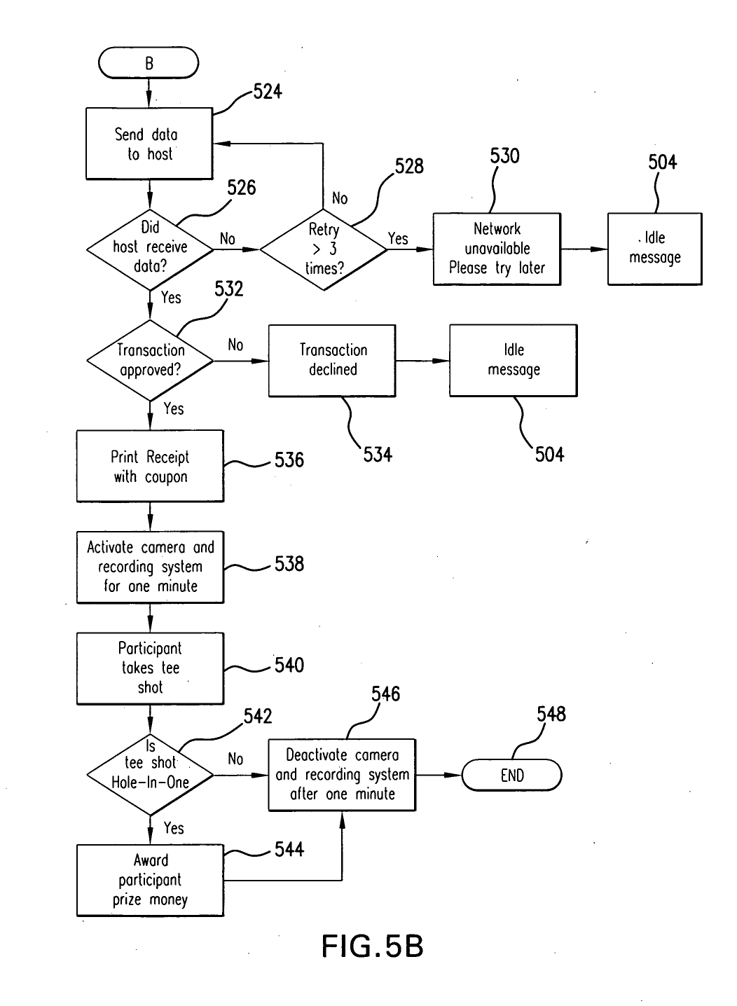

FIGS. 5A and 5B are flow charts illustrating the method of administering a golf related contest of the present invention through the use of software 414 of kiosk system 400 (both of FIG. 4) in accordance with an embodiment of the present invention. The procedure of FIGS. 5A and 5B starts in step 502, and proceeds to step 504 where the user first witnesses an idle message on screen 202 of kiosk 102. Preferably, the idle message will welcome the participant and request the participant to touch the screen to begin. Next, in step 506 it is determined if the participant has touched the screen. If the participant did not touch the screen the idle message will remain on the screen, however if the participant touched the screen the software proceeds to the next step. In step 508 the participant is presented with the following choices, the participant may select to participate in the contest, request additional information, or cancel the transaction. If the participant chooses to cancel the transaction or if a specified amount of time has passed (e.g., one minute) without the user making a selection, the software returns to the idle message of step 504. If the participant requests additional information, the system displays additional information regarding the golf contest in step, 510. After a certain amount of time, the system will automatically return to step 508. If the participant selects to play, the software proceeds to step 511, wherein the software initiates the advertisement and coupon generating sequence. During step 511 the software provides an interactive advertisement and coupon generating sequence, whereby the user views a plurality of advertising icons 224 and on-screen instructions 222 and is subsequently given the opportunity to choose to view additional information regarding a participating third party merchant and subsequently receive a coupon to any merchant as chosen by the user. Step 511 will be discussed in further detail below with regards to FIG. 7.

Once the user has completed the coupon generating sequence, the software proceeds to step 512, wherein the participant must select the method of payment. Preferably, in step 512, the participant may select from paying with a cellular telephone, with cash including bills and coins, or with any type of card that can make payments (e.g. a credit card, a debit card, a smart card, etc.). If the participant chooses to pay with cash, the software proceeds to step 514 and allows the participant to initiate payment with cash (e.g. bills and coins). If the participant chooses to pay via a cellular telephone, the software proceeds to step 516 and allows the participant to initiate payment through a cellular telephone. If the participant chooses to pay with a card, the software proceeds to step 518 and allows the participant to initiate payment via a card (e.g. a credit card, a debit card, a smart card, etc.). Once payment has been initiated, the process continues to step 520, and attempts to determine if a payment has been made. If a payment has not been made, the process continues to step 522 and attempts to determine if the participant attempted to cancel the transaction. If the participant attempted to cancel the transaction, the screen returns to step 504 where the idle message is once again displayed. However, if the participant did not attempt to cancel the transaction, the process returns to step 520 and once again attempts to determine if a payment was made. This cycle continues until the payment is made, the participant attempts to cancel the transaction, or the transaction times out. Preferably, if the system remains idle for more than thirty seconds the transaction times out and the system returns to step 504.

Once the payment is made, the payment data is transmitted to the host in step 524. Preferably, the data is transmitted via any appropriate wireless medium commonly known in the art, without departing from the spirit of the present invention. In step 526 it is determined if the host received the payment data. If the data has not been received, it is determined if more than three attempts have been made to contact the host in step 528. If more than three attempts have been made to contact the host the process continues to step 530 and a message is displayed on the screen alerting the participant that the network is currently unavailable. Additionally, the participant is instructed to try again later and the software returns to step 504, where the idle message is once again displayed. If less than three attempts to contact the host have been made, the process loops back to step 524 and attempts to send the payment data to the host. Either the kiosk connects to the host, at which point the process continues on to step 532 or the process fails to connect to the host, and returns to step 504, where the idle message is displayed.

Furthermore, if the kiosk successfully connects to the host the process continues to step 532, where the host must approve the transaction. If the transaction is declined a message is displayed indicative of this occurrence in step 534, and the process continues to step 504, where the idle message is displayed. If the transaction is approved, a receipt regarding the transaction is printed in step 536. The receipt preferably contains a coupon on the reverse side. Subsequently, in step 538 the cameras and golf contest system are activated for preferably a one minute time period. The participant is then expected to take a tee shot in step 540. Consequently, in step 542, it is determined if the tee shot landed in the cup for a hole-in-one. If the tee shot landed in the cup, the participant is awarded the prize money in step 544. Within approximately one minute of activating the golf contest system, the golf contest system deactivates in step 546, regardless of the results of the tee shot, where the procedure finally ends in step 548.

While the above method describes only one player participating in the golf contest of the present invention, it should be appreciated that the method may be repeated so that any number of players can participate in the golf contest of the present invention. As such, the method described above may be performed for any number of players willing to participate in the golf contest of the present invention.

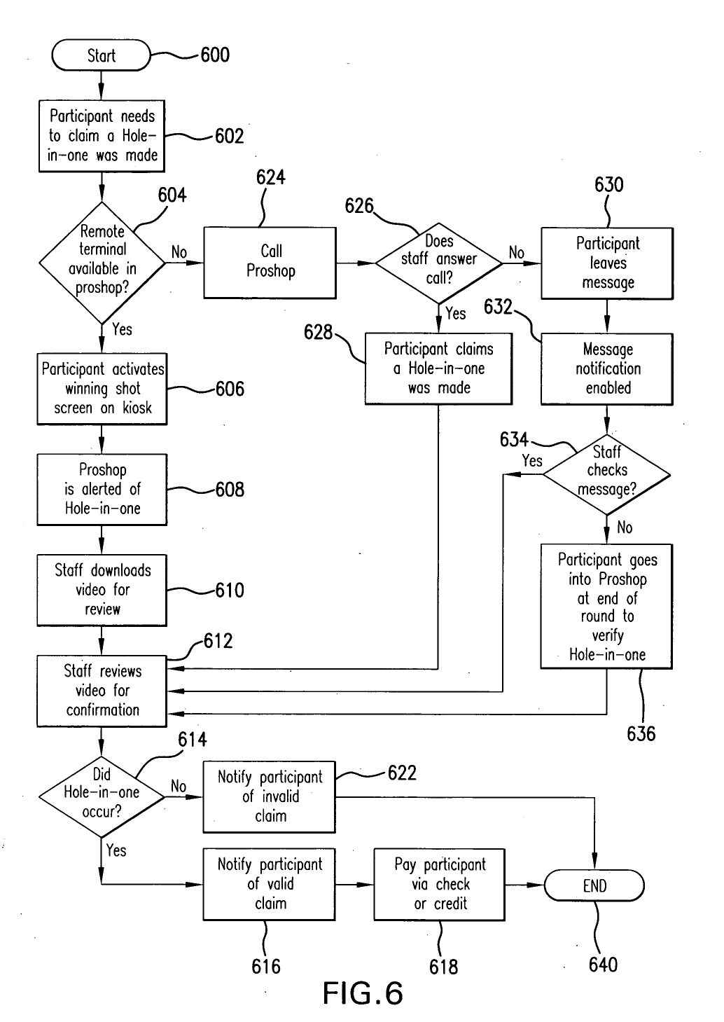

Turning now to FIG. 6, a flow chart illustrates the manner in which a participant may claim a hole-in-one in accordance with the present invention. The process begins in step 600 and proceeds to step 602 where a participant believes a hole-in-one was made, and thus needs to claim the reward. It is determined if a remote terminal is located inside the ProShop in step 604. If a remote terminal is located inside the ProShop, the participant activates the winning shot screen on the screen of a kiosk in step 606. Preferably, an additional kiosk exists right next to the putting green area so that the participant does not have to travel all the way back to the tee-box and risk the possibility of disrupting the continuity of the game. Once the winning shot screen is activated, the ProShop is alerted of a possible hole-in-one in step 608. Moreover, a participant may also claim a hole-in-one by calling a predetermined telephone number that automatically alerts the appropriate party of hole-in-one claim. Subsequently, a ProShop employee or any appropriate person downloads the video from the kiosk in step 610, whereby the employee reviews the video in an effort to confirm or deny the participant's claim in step 612. In step 614, the employee determines if the hole-in-one actually occurred. If a hole-in-one did occur, the employee notifies the participant of the valid claim in step 616. The participant may be notified of a valid claim through a variety of means (e.g. via cellular telephone, kiosk, display on golf cart, etc.). After being notified of a valid claim, the participant then receives the reward in step 618 and the procedure ends in step 640. The participant is afforded the opportunity to receive the reward through various means, such as by accepting a check, accepting cash, receiving a wire transfer, etc. Any payment method may be used without departing from the spirit of the present invention. If a hole-in-one did not occur, the participant is notified of the invalid claim in step 622, via means as previously discussed, and the procedure ends in step 640.

However, if in step 604 it is determined that the ProShop does not contain a remote terminal the user must call the ProShop in step 624. In step 626, it is determined if an employee at the ProShop answers the call from the participant. If an employee answers the call, the participant claims a hole-in-one over the telephone in step 628. Consequently, the process proceeds to step 612 and repeats the procedure as outlined above. In this case, since the ProShop does not contain a remote terminal, the employee preferably travels to the golf hole and witnesses the video directly on the kiosk. Preferably, only employees can playback videos, thus eliminating the opportunity for participants to tamper with videos and possibly deceive employees in an effort to collect rewards under false pretenses.

Conversely, if no one is available to answer the participant's call, the participant must leave a message indicating the hole-in-one claim in step 630. Subsequently, in step 632 the message notification system is enabled at the ProShop. The message notification could be a light on the phone, a series of beeps or any other method as commonly known in the art. In step 634 it is determined if the message left by the participant has been reviewed. If the message has been reviewed, the system proceeds once again to step 612 and repeats the procedure as outlined above, whereby the employee preferably returns to the kiosk at the hole to play back the video. If the message is never checked, the process continues to step 636, where the participant enters the ProShop at the end of his or her round of golf and personally claims a hole-in-one. Upon making the claim in person, the process continues once again to step 612 and repeats the procedure as outlined above, whereby the employee preferably returns to the kiosk at the hole to play back the video.

FIG. 7 is a flow chart illustrating the method of advertising and generating a coupon during the initiation of a golf related contest of the present invention through the use of software 414 of kiosk system 400 (both of FIG. 4) and interaction from a user in accordance with an embodiment of the present invention. The procedure of FIG. 7 starts in step 700, and proceeds to step 702 where the user first observes a main menu 220 on screen 202 of kiosk 102. Preferably, main menu 220 comprises a plurality of advertising icons 224 and will request the participant to select a coupon by touching an advertising icon 224. Next, in step 704 it is determined if the participant has made a selection. If the participant does not make a selection after a certain period of time, the system will timeout and the idle message will reappear on screen 202 in step 706. The idle message of step 706 is preferably the same idle message discussed above with regards to step 504. If, however, the participant touched a particular advertising icon 224, the software determines that a selection has been made by the participant and proceeds to the next step.

In step 708 the participant is presented with additional information regarding the particular third party merchant chosen by the participant. As discussed above, the additional information may be the actual value of the coupon and any limitations a participant may have when using the coupon. The participant is also presented with some additional choices in step 710. The participant may choose to confirm the initial selection or return to main menu 220 in order to view additional advertisements and/or coupons. If the participant did not confirm the initial selection, the software must then determine if the participant has selected to return to main menu 220 in step 712. If the participant did not select to return to main menu 220 after a particular amount of time the system will timeout and return to idle message 706. However, if the participant did select to return to main menu 220, the software returns to main menu 220 of step 702 and once again displays advertising icons 224. If the participant has confirmed the initial selection in step 710, the software proceeds to step 714, where it transmits a signal to receipt dispensing member 212 indicating the appropriate coupon to print on the reverse side of receipt. The advertising and coupon generating procedure subsequently ends in step 716, whereby software 414 returns to the player initiation procedure of FIGS. 5A and 5B.

It should be appreciated that steps 700-716 are the steps software 414 of the present invention follows when performing step 511 of FIG. 5A. Thus, after software 414 performs step 508 and the user has decided to participate in the golf contest, it then performs steps 700-716, at which point software 414 proceeds to step 512.

In the preferred embodiment of the present invention, the system provides a system enabling participants to select coupons from a plurality of choices and attempt a hole-in-one on preferably a Par 3 golf course hole. The system preferably records high resolution full frame rate video as evidence of success or not at the hole-in-one attempt. The participant may call and report a claimed hole-in-one, at which time, a staff member will access and download the related video that corresponds to the participant's transaction receipt. After review, the staff member can award or deny the prize associated with successfully completing the hole-in-one challenge.

In Summary, the present invention comprises a kiosk, which may be present on a golf course. The kiosk of the present invention contains a display (e.g. screen) for interacting with the user and for displaying images of at least one golf ball for at least one player. Additionally, the kiosk of the present invention preferably contains at least one video recording device (e.g. video camera) for capturing an image of each participant. Additionally, the system of the present invention may contain an additional video recording device for tracking at least one golf ball for at least one player. Furthermore, the system of the present invention may further comprise a third video recording device (e.g. video camera) for tracking at least one golf ball for at least one player. However, it should be contemplated that any number of cameras may be used for security purposes and for tracking at least one golf ball for at least one player.

Preferably, the video recording devices of the present invention are powered via an easily available low cost method (e.g. solar panels). However, conventional power delivery methods may be used without departing from the spirit of the present invention. Importantly, the video recording device of the present invention is in communication with the kiosk, preferably through wireless means.

Thus, the video recording device of the present invention possess a wireless transmitter in order to transmit captured images and video to the kiosk or any other device (e.g. remote terminal, cellular telephone, personal digital assistant, portable computer, etc.), as well as a wireless receiver which enables an individual to control the camera remotely (e.g. from the kiosk), and to receive data from the camera of the present invention. This allows the user to verify any specific claimed outcome in a game of golf through a video or photo record.

It should be appreciated that a central system may be able to remotely retrieve any shot from any time of day from any golf hole throughout the world that utilizes the system of the present invention via a wireless medium in order to verify a hole-in-one claim.

Additionally, a user seeking to have a record of a particular play or outcome of a golf game may purchase such a record from the kiosk of the present invention, which may be operably connected to a set of cameras placed throughout the golf course.

From the foregoing description of the preferred embodiments, which have been set forth in considerable detail for the purpose of making a complete disclosure of the present invention, the present invention comprises a device and a method of using such device for providing and administering a golf contest, comprising a golf hole and golf contest system. The golf contest system is preferably comprised of a solar powered wireless kiosk, a solar powered wireless camera, and an additional solar powered wireless kiosk all controlled by user-friendly software. Accordingly, the golf contest system provides and administers a golf contest (e.g. a hole-on-one contest, a closest-to-pin contest, a furthest drive contest, etc.), whereby a golfer may participant in the golf contest.

The key features of the present invention presented above are described for illustrative purposes only and do not serve to limit the scope of the invention to the specific features listed, nor do they represent an exhaustive enumeration of all aspects of the invention. Accordingly, well known methods, procedures, and substances for both carrying out the objectives of the present invention and illustrating the preferred embodiment are incorporated herein but have not been described in detail as not to unnecessarily obscure novel aspects of the present invention.

While the present invention has been described with reference to the key features, preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. Thus, the scope of the invention shall be defined solely by the following claims.

Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A system for conducting a golf game, said system comprising:
a kiosk;
at least one first camera that records at least part of said golf game, wherein said at least one first camera generates a first record of said golf game;
a second camera that records at least part of said golf game, wherein said second camera generates a second record of said golf game; and
a display for viewing said first record and said second record.

2. The system according to claim 1 wherein said at least one first camera is located by the tee area of a golf hole.

3. The system according to claim 1 wherein said at least one first camera is a wireless camera.

4. The system according to claim 1 wherein said second camera is a wireless camera.

5. The system according to claim 1 wherein said kiosk comprises a solar panel for supplying power to said kiosk.

6. The system according to claim 1 wherein said at least one first camera comprises a solar panel for supplying power to said first camera.

7. The system according to claim 1 wherein said second camera comprises a solar panel for supplying power to said second camera.

8. The system according to claim 1 and further comprising a power system for supplying power to said system.

9. The system according to claim 1 wherein said kiosk, said at least one first camera, and said second camera comprise a transmitter and a receiver for transmitting and receiving data.

10. The system according to claim 9 wherein said transmitter and said receiver are wireless.

11. The system according to claim 1 wherein said kiosk comprises a payment apparatus, for collecting a payment from a user.

12. The system according to claim 11 wherein said kiosk further comprises a receipt dispensing member for providing a receipt upon collection of said payment.

13. The system according to claim 1 wherein said kiosk is located by the tee area of a golf hole.

14. The system according to claim 1 wherein said second camera is located by the green area of a golf hole.

15. The system according to claim 9 wherein said transmitter and said receiver are used to establish a connection between said kiosk and a database remote from said kiosk.

16. The system according to claim 1 wherein said kiosk comprises a camera, wherein said camera generates a record containing the identity of a participant.

17. The system according to claim 1 wherein said kiosk comprises a display.

18. The system according to claim 17 wherein said display is configured to present an interactive advertisement.

19. The system according to claim 18 wherein said interactive advertisement allows a user to select a desired advertisement, wherein said user subsequently receives a coupon associated with said desired advertisement.

20. A method for conducting a golf game, the method comprising:
initializing the golf game via a kiosk;
participating in the golf game;
recording at least part of the golf game via at least one camera;
generating a record associated with the at least part of the golf game via a processor; and
accessing the record associated with the at least part of the golf game via a display.

21. The method according to claim 20 wherein the kiosk is coupled to the at least one camera.

22. The method according to claim 20 and further comprising a solar panel for supplying power to the kiosk and the at least one camera.

23. The method according to claim 20 and further comprising a power system for supplying power to the kiosk and the at least one camera.

24. The method according to claim 20 and further comprising at least a second camera, wherein the second camera is wireless.

25. The method according to claim 24 wherein the kiosk and the at least second camera further comprise a transmitter and a receiver for transmitting and receiving data between the kiosk and the at least second camera.

26. The method according to claim 25 wherein the transmitter and the receiver are wireless.

27. The method according to claim 20 and further comprising collecting a payment from a user via a payment apparatus.

28. The method according to claim 27 and further comprising providing a receipt to the user via a receipt dispensing member upon collecting the payment.

29. The method according to claim 20 wherein the kiosk is located by the tee area of a golf hole.

30. The method according to claim 26 wherein the at least second camera is located by the green area of a golf hole.

31. The method according to claim 25 wherein the transmitter and the receiver are used to establish a connection between the kiosk and a database remote from the kiosk.

32. The method according to claim 20 wherein the processor is coupled to the kiosk.

33. The method according to claim 24 wherein the processor is coupled to the at least second camera.

34. The method according to claim 20 wherein the display is coupled to the kiosk.

35. The method according to claim 34 and further comprising participating in an interactive advertisement configured to be provided on the display.

36. The method according to claim 35 wherein the interactive advertisement allows a user to select a desired advertisement, and further wherein the user subsequently receives a coupon associated with the desired advertisement.

37. A system for conducting a golf game, said system comprising:
a kiosk configured to administer said golf game;
at least one camera coupled to said kiosk that records and generates a record of at least part of said golf game; and
a display coupled to said kiosk configured to present an interactive advertisement.

38. A method for conducting a golf game, the method comprising:
initializing the golf game via a kiosk;
participating in an interactive advertisement;
participating in the golf game;
recording at least part of the golf game via at least one camera;
generating a record associated with the at least part of the golf game via a processor; and
accessing the record associated with the at least part of the golf game via a display.
